(19) United States
(12) Patent Application Publication
(10) Pub. No.: US 2014/0161442 A1
(43) Pub. Date: Jun. 12, 2014

(54) DATA SENDING OR RECEIVING METHOD, DEVICE, AND APPARATUS USED IN OPTICAL FIBER TRANSMISSION

(71) Applicants: Jun Yang, Shenzhen (CN); Lin Cheng, Shenzhen (CN)

(72) Inventors: Jun Yang, Shenzhen (CN); Lin Cheng, Shenzhen (CN)

(73) Assignee: AEROSPACE SCIENCE & INDUSTRY SHENZHEN (GROUP) CO., LTD., Shenzhen (CN)

(21) Appl. No.: 14/233,604

(22) PCT Filed: Aug. 8, 2012
(86) PCT No.: PCT/CN2012/079850

§ 371 Date: Jan. 17, 2014

(30) Foreign Application Priority Data
Oct. 20, 2011 (CN) 201110320866.7

(51) Int. Cl. H04B 10/2507; H04B 10/69; H04B 10/079; H04B 10/50

(52) U.S. Cl. CPC H04B 10/2507; H04B 10/50; H04B 10/697; H04B 10/0795
USPC 398/23; 398/192; 398/141; 398/208; 398/24

(57) ABSTRACT

The present invention relates to a fiber transmission field and provides a data sending or receiving method, device, and apparatus used in optical fiber transmission. The method includes: detecting data to be transmitted; encoding one bit pulse width to M parts if the to-be-transmitted data is 0, wherein the first part is a high-level, the later M−1 part is a low-level; encoding one bit pulse width to N parts if the to-be-transmitted data is 1, wherein the first part is a high level, and the later N−1 part is a low-level, the M is not equal to the N but both are integer which is greater than or equal to 2; and sending the encoded level signal. The embodiments of the present invention is for transmitting the binary data to be transmitted by the encoding way to changing the bit width of the data, namely, encoding the binary data 0 and 1 using different number of bits when the bit pulse width of the binary data 0 and 1 are the same, thereby two successive binary data 1 can not appear in the data transmission process, thus avoids signal jitters when the fiber transmits the data with a low speed.

### TECHNICAL FIELD

The present invention relates to fiber transmission field, and more particularly, to a data sending or receiving method, device, and apparatus used in optical fiber transmission.

### BACKGROUND

Because the fiber transmission has the features of such as far transmission distance, fast transmission speed, and simple transmission way, in the far distance wire transmission ways, the fiber transmission is used widely. The fiber transmission is always used to high speed data transmission. However, when the data transmission is in a low speed data transmission environment, due to its own characters, when two binary number “1” appear successively, the fiber signal will jitter, and thus results in data distortion during a data acquisition and the data can not be transmitted correctly.

The known technology for solving the above problem is to use the Manchester Encoding to ensure the maximal number of the successive binary number is 2. However, when the Manchester Encoding is applied to the malfunction indicating apparatus, due to the multiple paths and single wire way is used to transmits the data, in order to minimize the influence to the data transmission caused by the clock of the two ends of the data, the data transmitting speed should be reduced to a lower level (such as 4 kbit/s), however, the lower speed results in jitter of the fiber signal during the data transmission when the Manchester Encoding is used.

### SUMMARY

The object of the present invention is to provide a data sending method for solving the signal jitters when the fiber transmits the data in a low speed.

The present invention is realized by the data sending method used in optical fiber transmission, the method includes:
detecting data to be transmitted;
encoding one bit pulse width to M parts if the to-be-transmitted data is 0, wherein the first part is a high-level, the later M−1 part is a low-level; encoding one bit pulse width to N parts if the to-be-transmitted data is 1, wherein the first part is a high level, and the later N−1 part is a low-level, the M is not equal to the N but both are integer which is greater than or equal to 2;
sending the encoded level signal.

Another object of the present invention is for providing a data receiving method used in optical fiber transmission for receiving the data sending by the method as claimed in any one of the claims 1-3, the method includes:
detecting level signals;
receiving data 0 if detecting M−1 low-level(s) after a high-level in the level signal, and receiving data 1 if detecting N−1 low-level(s) after a high-level in the level signal, wherein the M is not equal to the N but both are integer which is greater than or equal to 2.

Another object of the present invention is for providing a data sending device used in optical fiber transmission, comprising:
a data detecting unit for detecting data to be transmitted;
a data encoding unit for encoding one bit pulse width to M parts if the to-be-transmitted data is 0, wherein the first part is a high-level, the later M−1 part is a low-level; and encoding one bit pulse width to N parts if the to-be-transmitted data is 1, wherein the first part is a high level, and the later N−1 part is a low-level, the M is not equal to the N but both are integer which is greater than or equal to 2; and
a sending unit for sending the encoded level signal.

Another object of the present invention is for providing a data receiving device used in optical fiber transmission, the device includes:
a signal detecting unit for detecting level signals;
a decoding unit for receiving data 0 if detecting M−1 low-level(s) after a high-level in the level signal, and receiving data 1 if detecting N−1 low-level(s) after a high-level in the level signal, wherein the M is not equal to the N but both are integer which is greater than or equal to 2.

Another object of the present invention is for providing a data sending apparatus which includes the data sending device.

Another object of the present invention is for providing a data receiving apparatus which includes the data receiving device.

The embodiment of the present invention is for transmitting the binary data to be transmitted by the encoding way to changing the bit width of the data, namely, encoding the binary data 0 and 1 using different number of bits when the bit pulse width of the binary data 0 and 1 are the same, thereby two successive binary data 1 can not appear in the data transmission process, thus avoids signal jitters when the fiber transmits the data with a low speed.

### BRIEF DESCRIPTION OF THE DRAWINGS

FIG. 1 is a flow chart of a method for sending a data transmitted by a fiber in accordance with a first embodiment of the present invention.

FIG. 2 is a flow chart of a method for receiving a data transmitted by a fiber in accordance with a second embodiment of the present invention.

FIG. 3 a structure diagram of a data sending device used in optical fiber transmission in accordance with a third embodiment of the present invention.

FIG. 4 a structure diagram of a data receiving device used in optical fiber transmission in accordance with a fourth embodiment of the present invention.

### DETAILED DESCRIPTION OF THE PREFERRED EMBODIMENTS

In order to make the objects, technology schemes, and advantages of the present invention are more clearly, embodiments of the present invention will be explained below in detail with reference to the accompanying drawings. It should be understood that the embodiments described below are only used to explain the present invention, and not intend to limit the present invention.

The embodiment of the present invention uses the encoded way for changing the bit width to transmit binary data which are to be transmitted (hereafter to-be-transmitted data), namely, using the different number of the bits of the data to encode the binary data “0” and “1” in the same bit pulse width. Thereby, two successive binary data “1” can not appear in the data transmitting process, thus the signal jitters can be avoided when the data are transmitted in low speed.

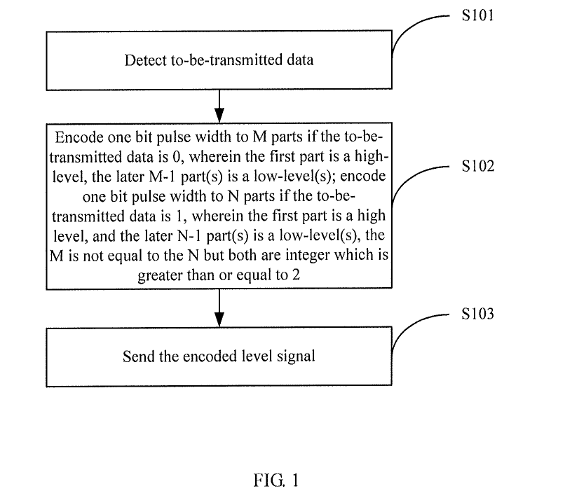

FIG. 1 is a flow chart of a method for sending a data transmitted by a fiber in accordance with a first embodiment of the present invention. The method includes:

Step S101, detecting the to-be-transmitted data.

In the embodiment, the to-be-transmitted data is a binary data “0” or “1”, and one bit binary data occupies one bit pulse width.

Step S102: encoding one bit pulse width to M parts if the to-be-transmitted data is 0, wherein the first part is a high-level, the later M−1 part(s) is a low-level(s); encoding one bit pulse width to N parts if the to-be-transmitted data is 1, wherein the first part is a high level, and the later N−1 part(s) is a low-level(s), the M is not equal to the N but both are integer which is greater than or equal to 2;

Step S103: sending the encoded level signal.

In the embodiment, encoding the binary data 0 and 1 with different bit width, and all the encoding ways are beginning with the binary data 1, and the later bits are all binary data 0, thus two successive 1 are avoided being shown during the data transmitting.

As a preferred embodiment of the present invention, specifically, in step 102, the following encoding way can be used to transmit data, namely, when the to-be-transmitted data is 0, encoding one bit pulse width to two parts, the first part is a high level, and the later part is a low level, namely, two bits 0 and 1 are used to represent the data 0. When the to-be-transmitted data is 1, encoding one bit pulse width to three parts, the first part is high level, the later two parts are low level, namely, three bits 1, 0, an 0 are used to represent the data 1.

As a preferred embodiment of the present invention, specifically, in step 102, the following encoding way can be used to transmit data, namely, when the to-be-transmitted data is 0, encoding one bit pulse width to three parts, the first part is high level, the later two parts are low level, namely, three bits 1, 0, and 0 are used to represent the data 0. When the to-be-transmitted data is 1, encoding one bit pulse width to two parts, the first part is a high level, and the later part is a low level, namely, two bits 0 and 1 are used to represent the data 1.

Therefore, in the present embodiment, two successive binary data 1 can not appear during the data transmission by transmitting the level signal of the detected to-be-transmitted data as the encoding way described above, and thus avoids jitter of the signal in the data transmission process.

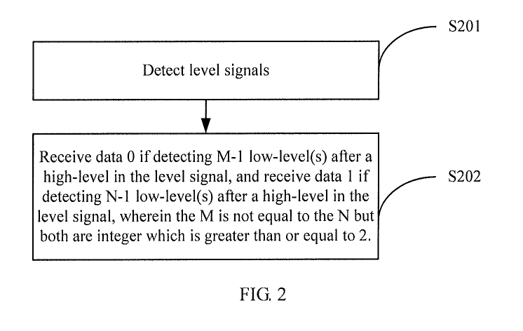

FIG. 2 is a flow chart of a method for receiving a data transmitted by a fiber in accordance with a second embodiment of the present invention. Based on the first embodiment, the second embodiment provides a method for receiving the data encoded by the data sending method provided in the first embodiment. The method for receiving the data includes:

S201: detecting level signals.

S202: receiving data 0 if detecting M−1 low-level(s) after a high-level in the level signal, and receiving data 1 if detecting N−1 low-level(s) after a high-level in the level signal, wherein the M is not equal to the N but both are integer which is greater than or equal to 2.

In a preferred embodiment, when two bits 1 and 0 are used to represent the data 0, three bits 1, 0, and 0 are used to represent the data 1, namely M=2, N=3, if the current level signal appears only one low level after one high level, data 0 is received, if the current level signal appears two successive low levels after one high level, data 1 is received.

In another preferred embodiment, when three bits 1, 0, and 0 are used to represent the data 0, two bits 1 and 0 are used to represent the data 1, namely M=3, N=2, if the current level signal appears only one low level after one high level, data 1 is received, if the current level signal appears two successive low levels after one high level, the data 0 is received.

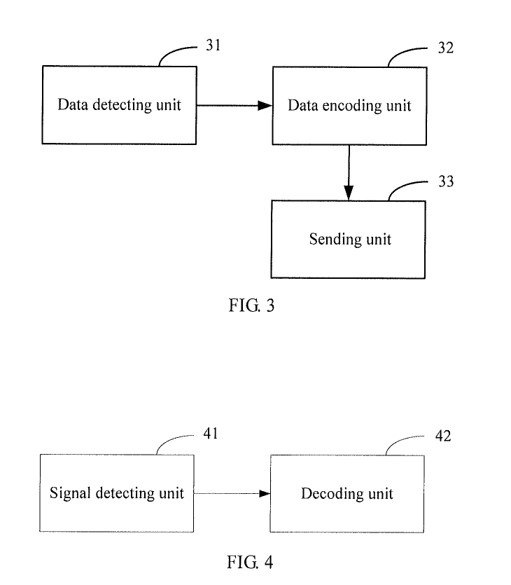

FIG. 3 a structure diagram of a data sending device used in optical fiber transmission in accordance with a third embodiment of the present invention. In order to easily describe, only the related parts of the present embodiment are shown.

As shown in FIG. 3, the data transmission device can be placed into a data transmission apparatus such as a malfunction indicating apparatus. Further, data transmission apparatus includes but not limited to the malfunction indicating apparatus.

The data transmission device includes a data detecting unit 31, a data encoding unit 32, and a sending unit 33

The data detecting unit 31 is configured for detecting the to-be-transmitted data.

The data encoding unit is configured for encoding one bit pulse width to M parts if the to-be-transmitted data is 0, wherein the first part is a high-level, the later M−1 part is a low-level; and encoding one bit pulse width to N parts if the to-be-transmitted data is 1, wherein the first part is a high level, and the later N−1 part is a low-level, the M is not equal to the N but both are integer which is greater than or equal to 2.

The sending unit 33 is configured for sending encoded level signals.

FIG. 4 a structure diagram of a data receiving device used in optical fiber transmission in accordance with a fourth embodiment of the present invention. In order to easily describe, only the related parts of the present embodiment are shown. The fourth embodiment is based on the data sending device of the third embodiment.

As shown in FIG. 4, the data receiving device can be placed into a data receiving apparatus such as a malfunction monitoring center. Further, the data receiving apparatus includes but is not limited to the malfunction monitoring center.

The data receiving device includes a signal detecting unit 41 and a decoding unit 42. The signal detecting unit 41 is configured for detecting the level signals.

The decoding unit 42 is configured for receiving data 0 if detecting M−1 low-level(s) after a high-level in the level signal, and receiving data 1 if detecting N−1 low-level(s) after a high-level in the level signal, wherein the M is not equal to the N but both are integer which is greater than or equal to 2.

The embodiments of the present invention transmits the binary data which is to be transmitted by the encoding way of changing the bit width, namely encoding the binary data 0 and 1 using different data bits in a situation that the data 0 and 1 have the same bit pulse width. Thereby, two successive binary data 1 can not appear during the data transmission, thus the signal jitters can be avoided when the data are transmitted in low speed.

The above description is just the preferred embodiment of the present invention, and is not intend to limit the present invention. The scope of the invention is indicated by the appended claims rather than by the foregoing description; and all changes which come within the meaning and range of equivalency of the claims are intended to be embraced therein.

What is claimed is:

1. A data sending method used in optical fiber transmission, comprising:
S1: detecting data to be transmitted;
S2: encoding one bit pulse width to M parts if the data to be transmitted is 0, wherein the first part is a high-level, the later M−1 part is a low-level; encoding one bit pulse width to N parts if the to-be-transmitted data is 1, wherein the first part is a high level, and the later N−1 part is a low-level, the M is not equal to the N but both are integer which is greater than or equal to 2, thereby encoding the to be transmitted data to level signals;
S3: sending the encoded level signals.

2. The data sending method as claimed in claim 1, wherein M=2, N=3.

3. The data sending method as claimed in claim 1, wherein M=3, N=2.

4. A data receiving method used in optical fiber transmission for receiving the data sending by the method as claimed in claim 1, comprising:
S1: detecting level signals;
S2: receiving data 0 if detecting M−1 low-level(s) after a high-level in the level signal, and receiving data 1 if detecting N−1 low-level(s) after a high-level in the level signal, wherein the M is not equal to the N but both are integer which is greater than or equal to 2.

5. A data sending device used in optical fiber transmission, comprising:
a data detecting unit for detecting data to be transmitted;
a data encoding unit for sending level signals based on the detected data to be transmitted, wherein encoding one bit pulse width to M parts if the to-be-transmitted data is 0; the first part is a high-level, the later M−1 part is a low-level; and encoding one bit pulse width to N parts if the to-be-transmitted data is 1; the first part is a high level, and the later N−1 part is a low-level, the M is not equal to the N but both are integer which is greater than or equal to 2; and
a sending unit for sending the encoded level signals.

6. A data receiving device used in optical fiber transmission, comprising:
a signal detecting unit being configured for detecting level signals;
a decoding unit for receiving data 0 if detecting M−1 low-level(s) after a high-level in the level signal, and receiving data 1 if detecting N−1 low-level(s) after a high-level in the level signal, wherein the M is not equal to the N but both are integer which is greater than or equal to 2.

7. A data sending apparatus, wherein the apparatus comprises the data sending device as claimed in claim 5.

8. The data sending apparatus as claimed in claim 7, wherein the data sending apparatus is a malfunction indicating apparatus.

9. A data receiving apparatus, wherein the apparatus comprises the data receiving device as claimed in claim 6.

10. The data receiving apparatus as claimed in claim 9, wherein the data receiving apparatus is a malfunction indicating apparatus.
